(19) United States
(12) Patent Application Publication
(10) Pub. No.: US 2023/0272232 A1
(43) Pub. Date: Aug. 31, 2023

(54) Low Temperature Antioxidant Reductant for Copper Nanoparticles

(71) Applicant: National Technology & Engineering Solutions of Sandia, LLC, Albuquerque, NM (US)

(72) Inventors: Nelson S. Bell, Albuquerque, NM (US); Timothy J. Boyle, Albuquerque, NM (US)

(21) Appl. No.: 18/105,973

(22) Filed: Feb. 6, 2023

Related U.S. Application Data
(60) Provisional application No. 63/314,671, filed on Feb. 28, 2022.

(51) Int. Cl. C09D 11/037; C09C 1/62; B22F 9/24; B22F 1/102; B22F 1/054

(52) U.S. Cl. CPC C09D 11/037; C09C 1/627; B22F 9/24; B22F 1/102; B22F 1/054; C01P 2004/64; B22F 2999/00; B22F 2302/45; B22F 2301/10; B22F 2998/10; B22F 2304/05

(57) ABSTRACT

The use of copper materials as a replacement for the more expensive coinage metals (i.e., silver, gold) in printed circuits has come to the forefront. For printing, the use of nanomaterials has allowed for significant advances through the use of nanoinks. Unfortunately, as the nanoregime is entered, the increased surface area leads to increased reactivity with atmospheric oxygen which results in a reduction in the conductivity of the printed circuits. To overcome this issue, a synthesis method uses a room temperature reduction of a copper organometallic precursor by the simple addition of catechol-based surfactants to prevent oxidation and agglomeration of the final copper nanoparticles. The selection of these catechol-based surfactants is based on non-aqueous solubility, high surface affinity, and anti-oxidative potential as surface ligands.

### CROSS-REFERENCE TO RELATED APPLICATION

This application claims the benefit of U.S. Provisional Application No. 63/314,671, filed Feb. 28, 2022, which is incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to printing inks and, in particular, to a low temperature antioxidant reductant for copper nanoparticle printing inks.

### BACKGROUND OF THE INVENTION

Copper nanoparticles are desired for direct write printing inks to lower cost and enable conformal coatings on arbitrary substrate topologies. Creating a copper nanoparticle ink, however, has several materials challenges as related to the printing process. Synthesis of copper nanoparticles requires a scalable synthesis route, but also must stabilize the particles in a solvent for printing and prevent oxidation of the copper nanoparticles to enable ink shelf life. There are a multitude of chemical synthesis approaches for copper nanoparticles in both polar and nonpolar solvents, with an according variety of surface terminations by capping agent or dispersant polymers. Water has been used in several preparation routes for copper but requires relatively strong reducing agents and high concentrations of dispersant polymers and anti-oxidant agents. Copper reduction in water is commonly performed using —OH containing organic molecules, including glucose or ascorbic acid, where the —OH groups are transformed into ketones. See Q. M. Liu et al., Trans. Nonferrous Met. Soc. China 22(9), 2198 (2012); Y. J. Tu et al., Org. Biomol. Chem. 15(20), 4417 (2017); and N. M. Zain et al., Carbohydr. Polym. 112, 195 (2014). Ascorbic acid is commonly used, through the formation of the dehydroascorbic acid, and has a pH dependence based on acid dissociation constants. See Y. J. Tu et al., Org. Biomol. Chem. 15(20), 4417 (2017). It is advantageous to utilize a single molecule as capping agent, anti-oxidant, and dispersant moiety. In the printing process, low surface tension and control over drying rate makes non-aqueous solvents a common choice for the carrier. An organic agent that suffices to disperse the particles for synthesis and printing is an advantage that requires the proper chemical design and properties.

The synthesis of copper nanoparticles primarily relates to the precursor used and the reductive power of the reducing agent. In non-aqueous solvents, the surface functionalization of metal nanoparticles must vary, with a surface affinity group for adhesion, and a stabilizing structure that mixes well with the non-aqueous solvent. Ayyappan described the use of alcohols for copper nanoparticle production, but reflux of ethyl alcohol with copper salts failed to have the reductive capacity to produce copper metals. See S. Ayyappan et al., J. Mater. Res. 12(2), 398 (2011). A stronger reducing agent in the form of magnesium metal was required, but failed to stabilize the particles even in the presence of polyvinylpyrrolidone, a common polyol route surfactant. Song describes the effect of polar solvents using bis(ethylhexyl) hydrogen phosphate as a surface ligand, where copper metal nanoparticles easily transform to the oxide in solvents with high dipole moments. See X. Song et al., J. Colloid Interface Sci. 273(2), 463 (2004).

### SUMMARY OF THE INVENTION

The present invention is directed to a method to synthesize catechol-stabilized copper nanoparticle printing inks, comprising providing a copper organometallic precursor solution comprising Cu²⁺ ions in a non-aqueous solvent, and adding a catechol-based reactant to the solution, thereby reducing the Cu²⁺ ions to Cu(0) and forming copper nanoparticles capped with catechol surface ligands. For example, the copper organometallic precursor can comprise a copper mesityl derivative and the non-aqueous solvent can comprise toluene or xylene. For example, the catechol-based reactant can comprise a catechol or a polyphenol comprising a benzene ring having at least two hydroxy substituents ortho to each other, such as propyl gallate, octyl gallate, lauryl gallate, 3,4 dihydroxybenzoic acid, 2,5 dihydroxybenzoic acid, 3,4 dihydroxybenzylaldehyde, 3,4 dihydroxyhydrocinnamic acid, indole-3-propionic acid, dopamine hydrochloride, 6,7 dihydroxycoumarin, alizarin, ascorbic acid-6-palmitate, α-tocopherol, catechin hydrate, or arbutin. The resulting catechol-based surface ligand can comprise two ortho hydroxyl groups of a benzene ring coordinated to the copper nanoparticle surface. The benzene ring can further comprise a dispersant moiety, such as a linear alkyl tail, a soluble polymer chain, or a branched alkyl structure.

### BRIEF DESCRIPTION OF THE DRAWINGS

The detailed description will refer to the following drawings, wherein like elements are referred to by like numbers.

FIG. 1 shows a number of catechol-based reactants: (a) propyl gallate (PG; 3,4,5-trihydroxybenzoic acid propyl ester), (b) octyl gallate (8G), (c) lauryl gallate (LG), (d) 3,4 dihydroxybenzoic acid (34 DHBz) protocatechuic acid), (e) 2,5 dihydroxybenzoic acid (25HBA; Gentisic acid, hydroquinonecarboxylic acid), (f) 3,4 dihydroxybenzylaldehyde (34DHBA), (g) 3,4 dihydroxyhydrocinnamic acid (34DHC; hydrocaffeic acid), (h) indole-3-propionic acid (IPC), (i) dopamine hydrochloride (Dope), (j) 6,7 dihydroxycoumarin (DHC; Esculetin), (k) alizarin (ALZ; 1,2-dihydroxyanthraquinone), (l) ascorbic acid-6-palmitate (AAP), (m) α-tocopherol (toco; Vitamin E), (n) catechin hydrate (Cat), and (o) arbutin (Arb).

FIG. 2 is an illustration of the catechol reduction reaction for the formation of catechol-stabilized copper nanoparticles.

FIG. 3 is an illustration of catechol adsorbate structure in which two hydroxyl groups are coordinated to the Cu nanoparticle surface.

### DETAILED DESCRIPTION OF THE INVENTION

A catechol is the ortho isomer of a benzenediol. Catechol chemistry is based on the hydroxyl moities which are surface active, leading to significant adhesion. These chemicals also are known as flavonoids if they are biologically produced, including gallic acid, catechin, and protocatechuic acids. See K. Srinivas et al., J. Chem. Eng. Data 55, 3101 (2010). For example, catechol derivation figures prominently in the salt water-based adhesion of mussel adhesive proteins. See J. Saiz-Poseu et al., Angew Chem. Int. Ed. Engl. 58(3), 696 (2019); and Z. Xu, Sci. Rep. 3, 2914 (2013). Hidber studied the adhesion of these types of compounds on Al₂O₃ powders, showing prominent adsorption capacity as the number of derivative —OH groups increased. See P. C. Hidber et al., J. Am. Ceram. Soc. 79(7), 1857 (1996). This has led to the use of gallic acid derivatives for control of suspension structure and rheological properties for nanoparticle suspensions. See A. R. Studart et al., J. Am. Ceram. Soc. 89(8), 2418 (2006). Lauryl gallate is recommended as a suitable surface derivative molecule to provide high solid loading and low viscosity in toluene, for example. Catechols have been used in the formation of dispersant polymers as a terminal functionalization that provides the surface attachment moiety. See Q. Zhang et al., Polym. Chem. 7(45), 7002 (2016). Wang studied the effectiveness of gallate esters with α-tocopherol in oxidation prevention of copper films. See Y. Wang et al., J. Dispers. Sci. Technol. 41(6), 909 (2019). This ligand combination was stated to have synergistic anti-oxidant behavior, with the best performance as shown by propyl gallate ester and the larger tocopherol as a combined oil aligned interface.

Catechols are also well known to chelate to copper in aqueous solutions and have been explored in numerous contexts. Petrou studied the formation of Cu(II) complexes with dihydrocaffeic acid, determining that 2:1 complexes via the formation of chelate rings. See A. L. Petrou et al., Transit. Met. Chem. 16, 48 (1991). Thompson and Calabrese characterized the coordination of copper ions with catechol derivatives, stating that each copper ion is coordinated to four oxygen atoms from two ligands. See J. S. Thompson and J. C. Calabrese, J. Am. Chem. Soc. 108, 1903 (1986). It is also possible to coordinate a fifth oxygen from the ligand at an axial position. These were interpreted with the Cu(II)-semi-quinone formulation and the copper oxidation of catechols by two one-electron transfer steps. Xu determined that catechols form metal coordination compounds with distorted planar square and octahedron configurations based on their oxygen donors. Xu described the nature of the bonds as partially electrostatic and partially covalent, dependent upon the cation. Near-covalent stiffness and strength of these complexes were found. See Z. Xu, Sci. Rep. 3, 2914 (2013).

The reducing action of catechol molecules is also a property related to molecular structure. Complexation with Cu(II) is noted as a method to catalyze oxidation of the catechols. See A. Neves et al., Inorg. Chem. 41(7), 1788 (2002). Catechols behave as reducing agents by their conversion to quinones, and Cu²⁺ is known to promote this conversion under basic conditions. See J. S. Thompson et al., J. Am. Chem. Soc. 108, 1903 (1986). Alcalde explored that strength for a series of polyphenols, with catechols included, and related to several food indexes of redox, anti-radical, and electrochemical properties. See B. M. Alcalde et al., Antioxidants (Basel) 8(11), 523 (2019). Compounds including gallic acid, quercetin, and luteolin showed high anti-oxidant responses. Higher activity was related to the structural position of hydroxyl groups—more than one hydroxyl group in the ortho or para position led to stronger activity. Gallic acid, 2,3-dihydroxylbenzoic acid, and 3,4 dihydroxybenzoic acid were very effective. Having the hydroxyl groups in the ortho and para positions correlated to low electrochemical potentials, on the order of 0.2-0.3 V, leading to a strong tendency for the material to undergo oxidation. Catechin had two oxidation peaks with values of 0.22 and 0.72 V.

The use of these materials in copper specifically has been investigated as well. Catapano studied the effect of a series of mono and dihydroxy coumarin derivatives on copper chelation and reduction ability. See M. C. Catapano et al., J. Trace Elem. Med. Biol. 46, 88 (2018). They present the effect of o-dihydroxycoumarins on copper reduction, with several compounds exhibiting a degree of reduction capability, although limited and affected by pH and concentration. They concluded that o-dihydroxycoumarins are moderately active cupric ion chelators and potent copper reductants.

Based on the chemistry of these materials, there is potential to utilize catechol molecules in the synthesis of copper nanomaterials. Yallappa used T. arjuna extract phytochemicals as a natural polyphenol surface protectant and anti-oxidant in the formation of copper nanoparticles, with very good antioxidant property. See S. Yallappa et al., Spectrochim. Acta A Mol. Biomol. Spectrosc. 110, 108 (2013). These reports state that several organic structures including flavonoids, proteins, terpenoids, tannins, polyphenols, etc., act as reducing agents for metal ions, and also as capping agents to minimize the agglomeration of nanoparticles. However, the reducing ability of the plant extracts required a microwave-based synthesis procedure. Other organic-molecule-stabilized copper nanoparticles have been formed using gelatin as a surface protective agent, but powerful reducing agents in the form of hydrazine were used to achieve copper reduction. See D. H. Zhang and H. B. Yang, Phys. B: Condens. Matter 415, 44 (2013). Zou produced copper nanoparticles via an aqueous route using dopamine, and demonstrated Fe³⁺ ion sensing ability via the specific interactions with catechols at the copper metal surfaces. See H. Y. Zou et al., RSC Adv. 5(69), 55832 (2015). This use of dopamine was also described by Chen, who stated that stable Cu nanoparticles were formed and exhibited the generation of reactive oxygen species. See C. Chen et al., Nanoscale 5(23), 11610 (2013).

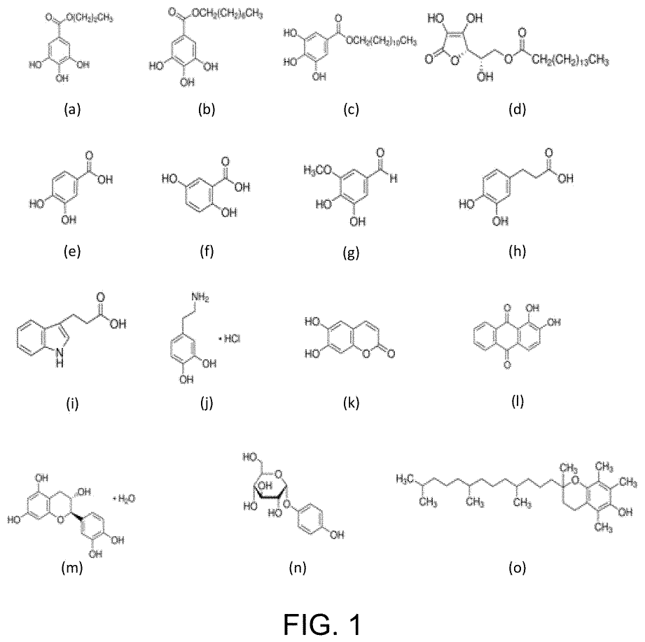

The present invention is directed to the use of non-polar soluble catechol-based molecules as a reductant and anti-oxidant capping agent during copper nanoparticle synthesis. A series of catechol-based molecules for copper nanoparticle synthesis were chosen based on fat solubility and cost. FIG. 1 shows exemplary catechol-based reactants (i.e., catechol or other polyphenol comprising a benzene ring having at least two hydroxy substituents ortho to each other) that can be used including, but not limited to: (a) propyl gallate (PG; 3,4,5-trihydroxybenzoic acid propyl ester), (b) octyl gallate (8G), (c) lauryl gallate (LG), (d) 3,4 dihydroxybenzoic acid (34DHBz) protocatechuic acid), (e) 2,5 dihydroxybenzoic acid (25HBA; Gentisic acid, hydroquinonecarboxylic acid), (f) 3,4 dihydroxybenzylaldehyde (34DHBA), (g) 3,4 dihydroxyhydrocinnamic acid (34DHC; hydrocaffeic acid), (h) indole-3-propionic acid (IPC), (i) dopamine hydrochloride (Dope), (j) 6,7 dihydroxycoumarin (DHC; Esculetin), (k) alizarin (ALZ; 1,2-dihydroxyanthraquinone), (l) ascorbic acid-6-palmitate (AAP), (m) α-tocopherol (toco; Vitamin E), (n) catechin hydrate (Cat), and (o) arbutin (Arb). These molecules serve the function of a reducing agent, an oxidative capping agent, and a dispersing ligand in the preparation of Cu nanoparticle-based inks.

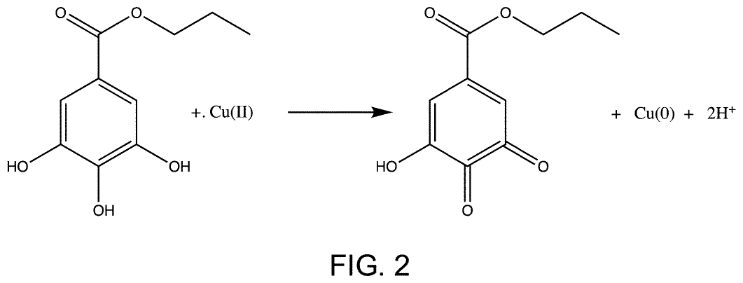

Catechol-stabilized copper nanoparticles can be prepared by reacting a mixture of a catechol-based reactant with a copper organometallic precursor, as shown in FIG. 2. The figure shows the reaction of propyl gallate via hydroxyl groups in adjacent (ortho) positions on the benzene ring. These agents undergo oxidation reactions to form ketones, in two stages. This results in the ortho-quinone form of the molecule. The Cu²⁺ ion source thereby is reduced to the metallic state. The Cu²⁺ ion source can be a metalorganic complex, such as those used by Bunge et al. for the formation of Cu⁰ nanoparticles. See S. D. Bunge et al., Nano Lett. 3(7), 901 (2003), which is incorporated herein by reference. For example, the mesityl (2,4,6-Me₃C₆H₂) complex is soluble in nonpolar fluids, or fluids with significant nonpolar character, such as hexadecylamine. Bunge at al. used the hot injection method to form these materials at 300° C. The present invention can use a copper mesityl derivative as a source material, with reduction by catechol at temperatures as low as 23° C. under anaerobic conditions (e.g., Ar glove box). The kinetics of the reaction vary, but this indicates that the reaction is energetically favored through the combination of these reactants. This is in accord with the propensity of catechols to oxidize, as noted earlier.

Critical to the production of a stable copper nanoink is the oxidation resistance of the produced materials to enable a longer shelf-life. The oxidation of metal thin films at low temperature is commonly discussed using Cabrera-Mott theory. See N. Cabrera and N. F. Mott, Rep. Prog. Phys. 12, 163 (1949). At the gas-metal surface, O₂(g) adsorbs and dissociates to give O²⁻ ions. Molecular 02(g) is expected to dissociate spontaneously at the copper metal surface. Using DFT, Lian et al. calculated that the energetic barriers for the process range from 0.95 to 0.31 eV, depending on the crystal orientation. See X. Lian et al., J. Chem. Phys. 145, 044711 (2016). The oxidation of Cu⁰ to Cu ions occurs by forming an oxide shell. The Cabrera-Mott studies show that the first two to three layers for most metals have a linear growth rate, which then becomes logarithmic under the influence of charge transport limitations. See F. P. Felner and N. F. Mott, Oxid. Met. 2, 59 (1970). This field-assisted activation of ion migration is believed to be greatly increased on nanoparticle materials and could rapidly increase the oxidation rate. See V. P. Zhdanov and B. Kasemo, Chem. Phys. Lett. 452(4-6), 285 (2008). Five-nm Cu nanoparticles oxidize completely to Cu₂O in air, whereas larger 30-nm particles form a stable Cu₂O shell under ambient conditions. See G. Cheng and A. R. Hight Walker, Anal. Bioanal. Chem. 396(3), 1057 (2010).

Strategies to prevent oxidation include forming a surface shell of an impermeable material (i.e., Ag(0), C, or an insoluble ionic complex) and/or dense, strongly bonded surface ligands that prevent oxygen reaction or transport, block oxygen adsorption, inhibit the formation of oxygen radicals, and/or prevent motion of a surface layer of Cu⁺ O bonds. The present invention uses organic surface ligands to create a stable interface to oxidation.

Insoluble ion complexes with Cu include copper formate, copper oxalate, and benzotriazole (BTAH) coordination compounds. BTAH is noted as one of the most effective organic materials to prevent corrosion. See M. Finsgar and I. Milosev, Corros. Sci. 52(9), 2737 (2010). BTAH acts as a surface inhibitor on copper through the formation of a passive layer, which is insoluble in aqueous and many organic solutions. It is believed to form a coordination polymer, but the full structure is still not defined. BTAH has been used in the modification of Cu nanoparticles and the formation of Cu-BTAH nanoparticles as precursor materials. Frignani utilized derivatives of BTAH with appended alkyl chains as an anti-corrosion protectant in bulk copper. See A. Frignani, Corros. Sci. 41, 1205 (1999). A Cu₂O surface oxide will provide the Cu(I) ions needed to react and form the surface layer. See J. C. Rubim et al., J. Mol. Struct. 100 (July), 571 (1893). Synergistic effects are noted for BTAH protection in the presence of benzyl amine, and in the presence of Fe. See M. Fleischmann et al., Electrochim. Acta 28(10), 1325 (1983); and J. L. Yao et al., Electrochim. Acta 48(9), 1263 (2003).

This core-shell concept can also be utilized with copper complexes of low stability; an example of which is shown using copper formate. Kim et al. synthesized air stable nanoparticles by controlling the surface capping agent. The cleaned particles were finally exposed to formic acid (1 g Cu nanoparticles to 3-30 mmol formic acid) to cause precipitation of copper formate shells. These particles were found to resist oxidation up to 150° C. Other examples include oxalate ions. Kanzaki provided a recent use of oxalic acid as a surface protective layer and as a reductant for low temperature consolidation. See M. Kanzaki et al., ACS Appl. Mater. Interfaces 9(24), 20852 (2017).

Catechol molecules can act as anti-oxidants and as surface modifier for Cu nanoparticles. In the present invention, the Cu nanoparticle surfaces are coordinated with the non-polar catechols as the stabilizing layer against oxygen reaction. Zhang studied the use of catechol polymers as routes for nanoparticle surface functionalization, noting the effect of catechols for ion chelation and the formation of self-healing gels. See Q. Zhang et al., Polym. Chem. 7(45), 7002 (2016). Dopamine has been used in prior work to form copper nanoparticles from aqueous salts. Also, catechol derivatives based on modified dopamine precursors have shown water-based synthesis of copper nanoparticles at 80 C. See H. Y. Zou et al., RSC Adv. 5(69), 55832 (2015).

Another function of a surface ligand is to provide repulsion between individual nanoparticles to prevent aggregation. Nanoinks require low surface tension, low viscosity, and control over drying rate to be printed. This involves a mixture of solvents within a miscible class of systems such as alcohol-glycol or aromatic solvents (toluene, xylene, tetralin, white spirits, etc.). The nanoparticles are generally dispersed effectively by the addition of short polymer layers that provide steric stabilization of the individual nanoparticles. Chen studied a series of catechol-based capping agents for the formation of copper nanoparticles. See C. Chen et al., Nanoscale 5(23), 11610 (2013). Their derivatives were terminated with groups to enable aqueous wetting and electrostatic dispersion. Similar examples of aqueous dispersible Cu nanoparticles were shown by Zou et al., using dopamine polymerization to create electrostatically charged nanoparticle dispersions. See H. Y. Zou et al., RSC Adv. 5(69), 55832 (2015). In the non-polar fluids used in jettable nanoinks, the surface structure of the ligand needs to exhibit good wetting and steric stabilization of the nanomaterials. The nonpolar synthesis by Bunge et al., for example, uses hexadecylamine (HDA) as the reaction solvent, leading to a surface ligand of the solvent around each nanoparticle. These long chain alkyls are effective dispersant layers for aromatic solvents, such as toluene and xylene. However, these HDA layers exhibit processing variability due to the need to reprecipitate them in alcohols to remove byproducts of the synthesis. It is known that small alcohols, such as methanol and ethanol, can penetrate and reside in the self-assembled monolayers formed by long chain alkyls. See G. Dabera et al, Nat. Commun. 8(1), 1894 (2017). This can allow for oxygen diffusion and destabilization of the nanoparticle dispersion. It is also stated that long chain alkyls are not that effective alone. A dense ligand structure that blocks oxygen diffusion appears to be critical, and mixed surface capping agents appear more effective in this regard, such as mixtures of HDA and isopropyl amine. See G. Dabera et al, Nat. Commun. 8(1), 1894 (2017).

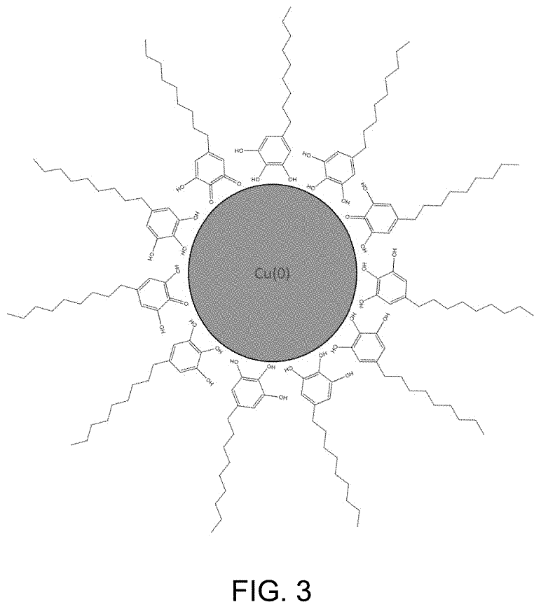

A strongly adsorbing structure based on catechols has the advantage of greater surface stability. A catechol adsorbate structure is shown in FIG. 3, in which two ortho hydroxyl groups of the benzene ring are coordinated to the Cu nanoparticle surface. The 4 position of the benzene ring has an octyl chain extending into the solvent as a dispersant moiety. This structure will exhibit good wetting behavior for aromatic solvent systems. For full surface coverage, the catechol molecules will inhibit oxygen transport or dissociation to stabilize the surface atoms. In the event that the catechol oxidizes to quinone, there will be a surface exchange with excess catechol in solution. Modification of the stabilizing group for solvent wetting will effectively prevent aggregation. This can be achieved with a sufficiently long linear alkyl tail (e.g., C8-C16), a soluble polymer chain up to molecular weight of 1000, or a branched alkyl structure. The capping structure can further comprise ligands having dispersing amine head groups to provide a mixed surface capping structure in order to retard oxidation.

The present invention has been described as a low temperature antioxidant reductant for copper nanoparticles. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method to synthesize catechol-stabilized copper nanoparticles for printing inks, comprising:
providing a copper organometallic precursor solution comprising Cu²⁺ ions in a non-aqueous solvent, and
adding a catechol-based reactant to the solution, thereby reducing the Cu²⁺ ions to Cu(0) and forming copper nanoparticles capped with catechol-based surface ligands.

2. The method of claim 1, wherein the copper organometallic precursor comprises a copper mesityl derivative.

3. The method of claim 1, wherein the non-aqueous solvent comprises toluene or xylene.

4. The method of claim 1, wherein the catechol-based reactant comprises a catechol or a polyphenol comprising a benzene ring having at least two hydroxy substituents ortho to each other.

5. The method of claim 4, wherein the catechol-based reactant comprises propyl gallate, octyl gallate, lauryl gallate, 3,4 dihydroxybenzoic acid, 2,5 dihydroxybenzoic acid, 3,4 dihydroxybenzylaldehyde, 3,4 dihydroxyhydrocinnamic acid, indole-3-propionic acid, dopamine hydrochloride, 6,7 dihydroxycoumarin, alizarin, ascorbic acid-6-palmitate, α-tocopherol, catechin hydrate, or arbutin.

6. The method of claim 1, wherein the catechol-based surface ligand comprises two ortho hydroxyl groups of a benzene ring coordinated to the copper nanoparticle surface.

7. The method of claim 6, wherein the benzene ring further comprises a dispersant moiety.

8. The method of claim 7, wherein the dispersant moiety comprises a linear alkyl tail, a soluble polymer chain, or a branched alkyl structure.
